(19) United States
(12) Patent Application Publication
(10) Pub. No.: US 2017/0189832 A1
(43) Pub. Date: Jul. 6, 2017

(54) COATED MESH AND ITS USE FOR OIL-WATER SEPARATION

(71) Applicant: BASF SE, Ludwigshafen (DE)

(72) Inventors: FRIEDERIKE FLEISCHHAKER, Ludwigshafen (DE); Christian RAITH, Mannheim (DE); Sylke HAREMZA, Neckargemuend (DE); Peter ZUROWSKI, Landau (DE)

(21) Appl. No.: 15/313,688

(22) PCT Filed: Apr. 1, 2015
(86) PCT No.: PCT/EP2015/057174

§ 371 Date: Nov. 23, 2016

(30) Foreign Application Priority Data
May 28, 2014 (EP) 14170268.8

(51) Int. Cl. B01D 17/04; C10G 33/06; C02F 1/00; B05D 1/18; B05D 1/02; B05D 3/06; C09D 5/16; C09D 4/06

(52) U.S. Cl. CPC B01D 17/045; C09D 5/1662; C10G 33/06; C09D 4/06; B05D 1/18; B05D 1/02; B05D 3/067; C02F 1/001; C02F 2101/325

(57) ABSTRACT

Process for manufacturing a coated mesh for oil-water separation by coating a mesh with a curable coating composition and crosslinking the coating thereby providing hydrophilic properties to the surface of the mesh, a coated mesh available by said process and the use of such coated mesh for oil-water separation.

The present invention relates to a method of manufacturing a coated mesh for oil-water separation by coating a mesh with a curable coating composition and crosslinking the coating thereby providing hydrophilic properties to the surface of the mesh. The invention furthermore relates to a coated mesh which is available by said manufacturing method and the use of such mesh for oil-water separation.

Oil-water separation is a worldwide challenge. Typical separation problems comprise the separation of emulsions of crude oil and (formation) water, the separation of industrial oily waste water or separation in connection with the removal of oil spills.

It is known in the art to separate oil-water emulsions or other oil-water mixtures by the addition of chemical additives such as demulsifiers and/or deoilers. Examples of such demulsifiers are disclosed for instance in EP-A 0 264 841, EP-A 0 499 068 or EP-A 0 267 517.

It is furthermore known to use materials which are capable of selectively absorbing organic solvents, including but not limited to oils. Examples comprise open-cell foams based on a melamine-formaldehyde resin modified with a hydrophobic coating such as disclosed in WO 2007/110361 A1 or WO 2008/107439 A1, J. K. Yuan, X. G. Liu, a Akbulut, J. Q. Hu, S. L. Suib, J. Kong, F. Stellacci, Nat. Nanotechnol. 2008, 3, 332 disclose superwetting nanowire membranes for selective absorption. Such membranes are obtained by coating nanowire membranes with silicones.

It has also been suggested to use a mesh for separation of oil and water.

L. Feng, Z. Y. Zhang, Z. H. Mai, Y. M. Ma, B. Q. Liu, L. Jiang, and D. B. Zhu, Angew. Chem. 2004, 116, 2046; Angew. Chem. Int. Ed. 2004, 43, 2012 disclose a super-hydrophobic and super-oleophilic coating mesh film for the separation of oil and water. The coating is performed by using a homogeneous emulsion comprising 50% by wt. of water, 30% by wt. of polytetrafluoroethylene (teflon), 10% by wt. of polyvinylacetate as adhesive , 8% by wt. of polyvinylalcohol as dispersant 2% dodecylbenzenesulfonate as surfactant. As shown in the cited document drops of water remain on the mesh and do not pass it while drops of diesel oil flow through the mesh.

However, the described hydrophobic/oleophilic oil-removing materials are easily fouled or clogged by oils. Thus, the separation efficiency is drastically reduced after a limited number of uses. Additionally, adhered oils are hard to remove which results in secondary pollution during this cleaning process as well as in a waste of both oil and oleophilic material.

Z. Xue, S. Wang, L. Lin, L. Chen. M. Liu, L. Feng and L. Jiang, Adv. Mater. 2011, 23, 4270-4273 disclose the manufacture of a superhydrophilic and underwater superoleophobic hydrogel-coated steel mesh for oil-water separation. The steel mesh was coated with a radiation curable, aqueous composition of acryl amide, N,N′-methylene bis acrylamide as crosslinker, a photoinitiator and high molecular polyacrylamide (Mₙ=3,000,000 g/mol) as adhesive agent and the coated mesh was cured with UV-light. The netting described has the opposite separation characteristics as compared to the netting described by L. Feng et al. A drop of water can pass through the netting while oil remains on the netting. Such materials have the advantage that they are easy to clean, the equipment is reusable, the oil-phase can be processed after separation and the equipment is protected from oil-fouling. However, the polyacrylamide coating described by Xue et al. suffers from a lack of efficiency and stability with respect to the separation of crude oil-water emulsions. Tests performed by the inventors showed that a mesh coated in the manner described separates hexane-water mixtures but does not separate sufficiently crude oil-water emulsions.

W. Zhang, Z. Shi, F. Zhang, X. Liu, J. Jin, and L. Jiang, Adv. Mater. 25, 2071-2076 disclose superhydrophobic and superoleophilic PVDF membranes for effective separation of water-in-oil emulsions with high flux. For the water-in-oil emulsions tested petroleum ether, toluene, isooctane and dichloromethane were used as oil phase. Emulsions of crude oil and water were not tested.

It was the objective of the present invention to provide an improved coated mesh being hydrophilic and oleophobic which also shows good results in the separation of crude oil-water emulsions.

Correspondingly, in a first aspect a method of manufacturing a coated mesh for oil-water separation has been found, wherein the method comprises coating a mesh with a curable coating composition and curing the coating by irradiation with UV comprising radiation and/or by annealing wherein the coating composition comprises at least
a polar solvent or solvent mixture,
a hydrophilic coating precursor selected from the group of
   hydrophilic, monoethylenically unsaturated monomers, with the proviso that at least one of the monomers is (meth)acryl amide,
   preformed hydrophilic oligomers and
   preformed hydrophilic polymers,
a hydrophilic crosslinker,
a hydrophilic polymerization initiator, and
a hydrophilic polymeric adhesion agent comprising acidic groups.

In a preferred embodiment, a method of manufacturing of a coated mesh for oil-water separation has been found, wherein the method comprises coating a mesh with a photochemically curable coating composition and curing the coating by irradiation with UV comprising radiation wherein the coating composition comprises at least
a polar solvent or solvent mixture comprising at least 70% by wt. of water relating to the total of all solvents used,
at least one hydrophilic, monoethylenically unsaturated monomer, with the proviso that at least 50% by wt.—relating to the total amount of all monomers used—is (meth)acryl amide,
a hydrophilic crosslinker comprising at least two ethylenically unsaturated groups,
a hydrophilic photoinitiator, and
a hydrophilic polymeric adhesion agent comprising acrylic acid,
   and wherein the mesh is a metal mesh having a mesh size of 10 μm to 100 μm.

In a second aspect a mesh for oil-water separation comprising a crosslinked hydrophilic coating has been found, wherein the mesh is available by a process as described above.

In a third aspect, the use of such mesh for oil-water separation has been found.

### LIST OF FIGURES

FIG. 1 Schematic representation of the testing device for the meshes

FIG. 2 Schematic representation of an oil-water separator equipped with meshes

With regard to the invention, the following should be stated specifically:

The coated mesh according to the present invention is available by coating an uncoated mesh with a curable coating composition followed by thermally and/or photochemically curing the coating. The coating provides hydrophilic surface properties to the mesh. Optionally, before coating the mesh a suitable precoating may be applied.

### Mesh Used for Coating

For manufacturing the coated mesh an uncoated mesh is used as starting material. Any suitable material for the mesh may be selected. Examples include meshes made of metals such as steel, stainless steel, bronze, brass, or aluminum or meshes made of polymeric materials such as polyethylene, polypropylene, polyacrylamide, or polyethersulfone. In one embodiment of the invention metals, preferably stainless steel is selected as material for the mesh.

The mesh may comprise wires or fibers which are arranged as a net but of course also other types of mesh may be used such as sheets with openings, e,g. openings stamped into the sheet. The latter method has the advantage that also openings having irregular shape may be used which may be difficult when using wires.

If the mesh comprises fibers and/or wires, such the fibers/wires of the net may have a thickness of 0.02 to 0.2 mm, for instance 0.03 mm to 0.1 mm.

The mesh and the geometry of the openings in the mesh used may be chosen by the skilled artisan according to his/her needs, for example in a tetragonal, hexagonal or octagonal manner or a combination of two or more than two geometries. Examples of tetragonal openings include squares, rectangles or parallelograms. Other shapes include circles, ovals, star-like openings or openings of irregular shape.

The mesh size may be chosen by the skilled artisan according to his/her needs. In particular, the mesh size may be from 10 μm to 100 μm, for example 50 μm to 70 μm. Said number relates to the longest straight distance from one point along the border of the opening to another point along the border of the same opening. By the way of example it may be the diagonal in a square, the long diagonal in a rectangle or the diameter of a circle. Should the mesh comprise different openings, the number relates to the arithmetic average.

### Curable Coating Composition

The curable coating composition may be a thermally and/or photocurable composition, preferably a photocurable composition. It provides hydrophilic, preferably superhydrophilic properties to the mesh coated with the formulation so that it may be suitable for oil-water separation. The term “superhydrophilic” means that the contact angle for an oil is >150° while the contact angle for water is <5°.

The curable coating composition according to the invention comprises at least a polar solvent, a hydrophilic coating precursor, a hydrophilic crosslinker, a hydrophilic initiator and a hydrophilic, polymeric adhesive agent.

### Solvent(s)

The curable coating composition comprises at least a polar solvent. The polar solvent may be water or an organic solvent miscible with water. Examples of polar organic solvents miscible with water comprise alcohols such as methanol, ethanol, propanol, isopropanol or ketones such as acetone.

In a preferred embodiment of the invention, the solvent at least comprises water. Besides water one or more than one additional polar organic solvents solvent miscible with water as defined above may be used. In one embodiment, the solvent comprises at least 50% by wt. of water relating to the total of all solvents, preferably at least 70% by wt. of water, more preferably at least 85% by wt., and most preferably only water is used as solvent.

The amount of polar solvent(s) in the curable coating composition may be selected by the skilled artisan according to his/her needs. Generally, the amount of polar solvent(s) is from 20% by. wt. to 90 by wt., preferably 40% by wt. to 60 by wt. % relating to the total of all components of the curable coating composition.

### Coating Precursor

The coating precursors are hydrophilic components and are selected from the group of hydrophilic, polymerizable monomers, preformed hydrophilic oligomers and polymers. Oligomers and polymers themselves may also comprise polymerizable group.

### Monomers

In one embodiment of the invention the crosslinkable composition comprises at least one monoethylenically unsaturated, hydrophilic monomer with the proviso that at least one of the monomers is (meth)acrylamide, preferably acrylamide.

Preferably, the hydrophilic monomers, oligomers or polymers used are miscible with water in any ratio, but it is sufficient for execution of the invention that the components dissolve in the coating composition. In general, the solubility of the hydrophilic monomers in water at room temperature should be at least 50 g/l, preferably at least 100 g/l.

Besides (meth)acrylamide, preferably acrylamide other monoethylenically unsaturated monomers may be used as comonomers. Examples of such further monomers comprise monomers comprising COOH-groups such as (meth)acrylic acid, fumaric acid, itaconic acid, crotonic acid, or maleic acid, monomers comprising other acid groups such as vinylphosphonic acid, esters of hydroxyethyl or hydroxypropyl(meth)acrylate with (poly)phosphoric acid, allylphosphonic acid, 2-acrylamido-2-methylpropanesulfonicacid, or vinylsulfonic acid, hydrophilic (meth)acrylates, for instance amino(meth)acrylates or such as dimethylaminoethyl(meth)acrylate, dimethylaminopropyl(meth)acrylate, 2-(2-dimethylaminoethyloxy)ethyl (meth)acrylate or amino(meth)acrylamides such as dimethylaminoethyl(meth)acrylamide or dimethylaminopropyl(meth)acrylamide, quaternized amino(meth)acrylates and quaternized amino(meth)acrylamides, hydroxyalkly(meth)acrylates, such as hydroxyethyl(meth)acrylate or hydroxypropyl(meth)acrylate, hydroxyalkyl(meth)acrylamides such as such as hydroxyethyl(meth)acrylamide or hydroxypropyl(meth)acrylamide, ureidomethacrylate, oligo- or polyethyleneglycol(meth)acrylates and/or -(meth)acrylamides or methyl oligo- or methylpolyethyleneglycol(meth)acrylates and/or -(meth)acrylamides, vinyl-and allyl-substituted heteroaromatic compounds, including vinyl- and allyl-substituted pyridines, pyrimidines, pyrroles and imidazoles such as vinylpyrrolidone.

Preferably, a monomer mixture comprising at least 50% by wt. of (meth)acrylamide, preferably acrylamide, more preferably at least 75% by wt. of (meth)acryl amide, preferably acrylamide may be used. In one embodiment of the invention only (meth)acryl amide, preferably acrylamide is used as monomer.

### Oligomers and Polymers

In another embodiment of the invention preformed hydrophilic oligomers or hydrophilic polymers may be used. Examples of such preformed polymers or oligomers comprise homopolymers or copolymers of the monomers mentioned above such as polyacrylamide or polyvinylpyrrolidone. Further examples comprise polyethyleneglycol or polyethyleneimine.

### Amount of Coating Precursors

The amount of monomers and/or oligomers and/or polymers in the curable coating composition may be from 2% by wt. to 80% by wt., preferably from 40% by wt. to 60% by wt. with respect to the total of all components of the coating composition.

In a preferred embodiment of the invention monomers are used as coating precursor.

### Crosslinkers

The coating composition furthermore comprises at least one hydrophilic crosslinker, i.e. components comprising at least two polymerizable groups. For reacting with monoethylenically unsaturated monomers the precursor comprises at least two ethylenically unsaturated groups.

Preferably, the crosslinkers used are miscible with water in any ratio, but it is sufficient for execution of the invention that the components dissolve in the coating composition. In general, the solubility of the crosslinkers in water at room temperature should be at least 50 g/l, preferably at least 100 g/l.

Examples of suitable hydrophilic crosslinkers comprise water soluble multifunctional acrylates, -acrylamides such as oligoethyleneglycoldiacrylates or N,N′-methylene bis acrylamide. Such crosslinkers are particularly preferred if monomers are used in the coating composition.

If oligomeric or polymeric precursors are used also such crosslinkers may be used. In one embodiment they are used together with additional monomers.

The amount of crosslinkers in the coating composition may be selected by the skilled artisan according to his/her needs. Generally, the amount may be from 0.5 to 10% by wt., preferably 0.5 to 5% by wt. with respect to the total of all components of the coating composition.

### Initiators

Hydrophilic initiators for initiating curing may be initiators for thermally initiating polymerization and/or photoinitiators. Preferably, photoiniators are used.

Preferably, the initiators used are miscible with water in any ratio, but it is sufficient for execution of the invention that the components dissolve in the coating composition.

Examples of photoinitiators comprise 2,2′-diethoxyacetophenone, mixtures of benzophenone and 2,2′-diethoxyacetophenone, oxy-phenyl-acetic acid 2-[2 oxo-2 phenyl-acetoxy-ethoxy]-ethyl ester and oxy-phenyl-acetic 2-[2-hydroxy-ethoxy]-ethyl ester, or phosphine oxides such as phenyl bis (2,4,6-trimethyl benzoyl) phosphine oxide. Of course a mixture of two or more initiators may be used.

Examples of thermal initiators comprise water soluble azo initiators or peroxo initiators.

The amount of initiators in the coating composition may be selected by the skilled artisan according to his/her needs. Generally, the amount may be from 0.5 to 7% by wt., preferably 1 to 5% by wt. with respect to the total of all components of the coating composition.

### Polymeric Adhesion Agents

The curing composition furthermore comprises at least one hydrophilic polymeric adhesion agent. The polymeric adhesion agent comprises acidic groups.

Preferably, the adhesion agents used are miscible with water in any ratio, but it is sufficient for execution of the invention that the components dissolve in the coating composition.

Examples of such acidic groups comprise carboxylate —COOH groups, sulfonic acid groups —SO₃H, or phophonic acid groups —P(O)(OH)2 groups. Preferably, the polymeric adhesion agent comprises at least carboxylate —COOH groups.

The polymeric adhesion agent may in particular comprise monoethylenically unsaturated monomers comprising acidic groups, preferably —COOH groups. Examples of suitable polymeric adhesion agents comprise polyacrylic acid or homopolymers or copolymers of fumaric acid, itaconic acid, crotonic acid, maleic acid, methacrylic acid and acrylic acid. Preferably, the adhesion agent comprises at least (meth)acrylic acid, preferably acrylic acid.

In one preferred embodiment of the invention polyacrylic acid is used, preferably polyacrylic acid having a weight average molecular weight M_{w} of more than 1,000,000 g/mol, for example 1,000,000 g/mol to 5,000,000 g/mol.

The amount of adhesion agents in the coating composition may be selected by the skilled artisan according to his/her needs. Generally, the amount may be from 0.1 to 5% by wt., preferably 0.2 to 2% by wt. with respect to the total of all components of the coating composition.

### Further Components

The curing composition may of course comprise further components. Such further components may be used modifying and/or fine-tuning the properties of the coating.

The coating components are made by mixing all components of coating composition.

### Method of Coating an Uncoated Mesh

In the method according to the invention an uncoated mesh which optionally might have been precoated is coated with the coating composition described above. Such coating may be performed by dipping an uncoated mesh into the coating composition. In another embodiment the coating composition may be sprayed onto the uncoated mesh. The thickness of the coating may be selected by the skilled artisan according to his/her needs. In one embodiment it may be from 0.5 μm to 2 μm.

After coating the mesh with the curable coating composition the film is crosslinked. In case of compositions comprising photoinitiators crosslinking is started by irradiating the meshs comprising an uncured coating with UV- or UV/VIS-radiation, for instance with a radiation of about 365 nm. In case of compositions comprising thermal initiators crosslinking is started by annealing the mesh coated with an uncured coating.

The process of coating the uncoated mesh may comprise additional steps.

In one embodiment, the mesh may be cleaned in an additional step before coating. Such a cleaning step may comprise removing organic impurities from a metal mesh using organic solvents such as acetone.

In another embodiment, the mesh may be precoated with adhesion agents before coating it with the curable composition. Examples of suitable adhesion agents comprise in particular the polymeric adhesion agents as described above.

### Preferred Process

In a preferred embodiment of the invention the process for manufacturing of a coated mesh for oil-water separation comprises coating a mesh with a photochemically curable coating composition and curing the coating by irradiation with UV comprising radiation.

In the preferred embodiment, the coating composition comprises at least a polar solvent or solvent mixture comprising water in an amount of at least 70% by wt. of water relating to the total of all solvents used. Preferably, the amount of water is at least 85% by wt., and more preferably only water is used as solvent.

As a further component, the preferred coating composition comprises at least one hydrophilic, monoethylenically unsaturated monomer, with the proviso that at least 50% by wt. relating to the total amount of all monomers used is (meth)acryl amide, preferably acrylamide. Preferably at least 75% by wt. of (meth)acryl amide, preferably acrylamide may be used, and most preferably only (meth)acryl amide, preferably acrylamide is used as monomer. Suitable hydrophilic comonomers which may be used besides (meth)acrylamide have already been described above.

As a further component, the preferred coating composition comprises at least a hydrophilic crosslinker comprising at least two ethylenically unsaturated groups. Examples of such crosslinkers have already been described above.

As a further component, the preferred coating composition comprises at least a hydrophilic photoinitiator. Examples of such photoinitiators have already been described above.

As a further component, the preferred coating composition comprises at least one hydrophilic polymeric adhesion agent comprising (meth)acrylic acid, preferably acrylic acid. In one preferred embodiment the adhesion agent comprises polyacrylic acid, preferably polyacrylic acid having a weight average molecular weight M_{w} of more than 1,000,000 g/mol, for example 1,000,000 g/mol to 5,000,000 g/mol.

Furthermore, in the preferred process the mesh is a metal mesh, preferably a mesh of stainless steel having a mesh size of 10 μm to 100 μm, preferably 40 μm to 60 μm.

### Coated Mesh

The coated meshs for oil-water separation according to the present invention are available by the process as described above including its preferred embodiments. A particularly preferred mesh is available by the preferred process as described above.

The meshs comprise a crosslinked hydrophilic coating which imparts hydrophilic properties to the surface of the mesh. The thickness of the coating may be selected by the skilled artisan according to his/her needs. In one embodiment it may be from 0.5 μm to 2 μm.

### Use of the Coated Meshs for Separating Oil-Water Separation

The mesh according to the invention may be used for oil-water separation.

The term “oil” as used herein encompasses any kind of organic liquids which form emulsions with water. Examples of oils include hydrocarbons, such as aliphatic and/or aromatic hydrocarbons, in particular hydrocarbons having a boiling point of more than 150° C., crude oil, condensate, mineral oils such as diesel oil, gasoline, heavy fuel oil, engine oil, vegetable oils such as coconut oil, tall oil or rape oil, or synthetic oils such as silicone oils. In one preferred embodiment of the oil is crude oil. The term water-oil mixtures shall include any kind of mixtures of oil and water comprising an oil phase and a water phase, including but not limited to oil-water emulsions or water-oil emulsions, in particular emulsions of crude oil and water such as formation water.

Examples of specific water-oil separation processes include separation processes in course of oil production and oil refining, such as the separation of emulsions of crude oil and water produced from an oil bearing formations, the separation of heavy oil emulsions from oil sands tailings or heavy oil emulsions obtained from SAGD techniques, desalting procedures (crude oil washing), de-oiling of water, oil sludge dewatering or the removal of hydrocarbons from drilling fluids. Further examples comprise the separation of oil-water mixtures from tank bottoms at refineries or other storage facilities, collections points for disposable waste oils, waste from chemical factories, ballast water, the removal of oil spills, or mist removal from gas streams.

In one preferred embodiment of the invention, the oil-water mixture to be separated is a mixture of crude oil and water, in particular an emulsion of crude oil and water.

In order to separate oil-water mixtures according to this invention the oil-water mixture may be pressed against a mesh. The force applied may simply be gravity forces but of course also pressure may be applied. Due to the (super)hydrophilic surface properties of the coated mesh, water may pass through the mesh while the passage of oil through the mesh is impeded so that at least part of the oil is retained on the mesh and may be removed from the mesh.

In one embodiment of the invention for the separation of oil-water mixtures a separating device is used which a least comprises: a first chamber at least comprising an inlet for fluids and an outlet for fluids, wherein the first chamber is connected with a second chamber at least comprising an outlet for fluids and wherein furthermore a coated mesh according to this invention separates the first chamber from the second chamber. In a preferred embodiment the device is a device for cross-flow filtration.

For separating oil-water mixtures using the device described, the oil-water mixture to be separated is allowed to flow into the first chamber. A suitable pressure selected by the skilled artisan may be applied. Water or at least part of the water of the oil-water mixture passes through the mesh into the second chamber and may be recovered from the second chamber from the outlet of the second chamber. Oil or an oil-water mixture with decreased water content may be recovered from the outlet of the first chamber. The process may be continuous or discontinuous. In a preferred embodiment the process is a continuous cross-flow filtration.

If one separating step is not sufficient to separate oil and water completely the separation step may be repeated using the same or another device. For example for separating a cascade of two or more of the devices described successively assembled may be used.

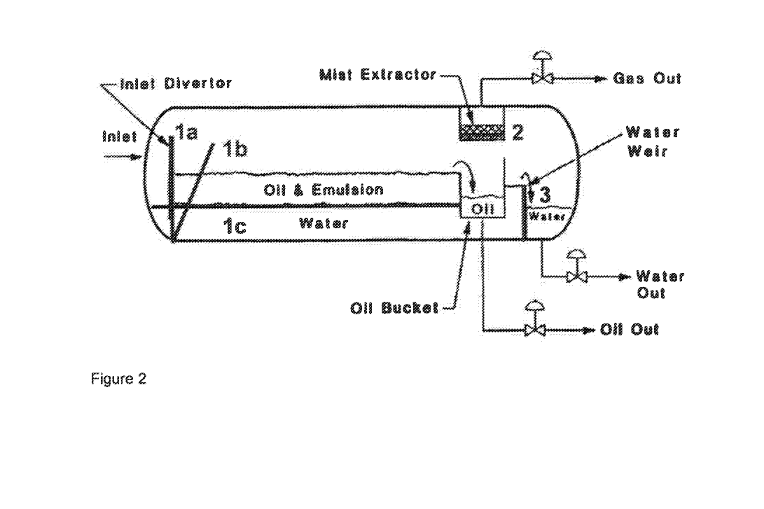

In one further embodiment a separator for the separation of crude oil and water may be used which is equipped with meshes according to the present invention. A schematic representation of such a separator is shown in FIG. 2. The separator is a cylinder shaped hollow body which at least comprises an inlet for an oil-water emulsion, an oil bucket for separated oil, outlets for separated water and separated oil and furthermore a mist extractor and an outlet for separated gas. Meshes may be incorporated vertically (1a) or almost vertically (1b) into the separator at a location close to the inlet for the oil-water emulsion. A mesh may also be incorporated horizontally. In such embodiment, the inlet for the oil-water emulsion is located above the mesh so that the emulsion may be separated into oil and water under the influence of gravity. In order to hold back oil spills a mesh may furthermore be used as water weir (3) and/or in the mist extractor (2). Of course the skilled artisan may use meshes in an oil-water separator in another manner.

### Advantages of the Present Invention

Using the coated meshes according to the present invention has the advantage that it is not necessary to use demulsifiers or deoilers for oil-water separation or it is at least possible to reduce the amount of demulsifiers and/or deoilers used.

The invention is illustrated in detail by the examples which follow.

### General Procedure for the Coating of a Metal Grid with Polymer Hydrogel

A stainless steel metal grid 1.4401 with square cells having a mesh size of 50 μm and a diameter of the wire of 0,036 mm was used. Pieces with a size of 5 cm×5 cm were cut. The metal grid pieces were cleaned with acetone, deionized water and again acetone and dried with air. In the next step, the cleaned metal grid piece was clamped on top of a 100 mL Schott glass bottle (GL 45 thread). The glass bottles with the metal grid on top were put upside down into the corresponding coating solutions (disclosed below) and then removed and cured under UV-light (365 nm). The thickness of the coatings thus obtained is between 0.5 and 2 μm.

For the comparative example C2 the mesh was pre-coated with an aqueous solution of polyethyleneimine having an average molar mass Mₙ of 750,000 g/mol (Lupasol® P) before coating with the corresponding coating solution. For this purpose, the glass bottles with metal grid on top were put upside down into the aqueous polyethyleneimine solution (1 mg/ml) for 15 min and then rinsed with deionized water. In the next step the hydrogel solution was coated as described above.

### Comparative Example 1

For coating, the hydrogel precursor solution described in Adv. Mater. 2011, 23, 4270 was used: 50 g acrylamide, 1.5 g N,N′-methyl-bis acrylamide (crosslinking agent), 1.0 g 2,2′-diethoxyacetophenon (photoinitiator) and 0.5 g polyacrylamide, having an M_{w} of 2,000,000 g/mole (adhesive agent) were dissolved in 47 g deionized water and stirred for 45 min. To achieve best solubilities, PAM is dissolved as the first ingredient.

### Example 1

The same composition as disclosed in comparative example Cl was used, however 0.5 g polyacryk acid (M_{w}3 Mio) was used instead of PAM as adhesive agent.

### Comparative Example 2

The same composition as for example 1 was used, but with additional adhesion layer of PEI (Mₙ750,000 g/mol). Application is described in the next paragraph.

### Example 2

The same composition as for example 1 was used, but instead of 50 g acrylamide, 25 g acrylamide and 25 g acrylic acid were used.

### Comparative Example C3

The same composition as for example 1 was used, but with 50 g acrylic acid instead of acrylamide

Oil-Water Separation Test

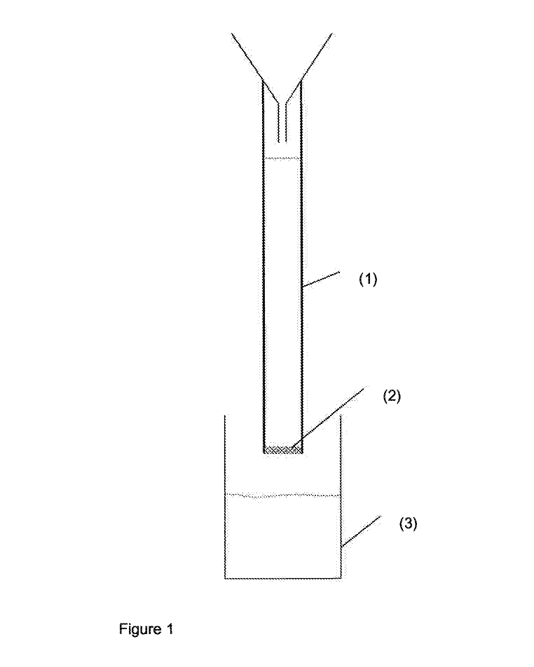

The coated grids were used for oil-water separation. The test apparatus is schematically shown in FIG. 1. A sample of the mesh (2) is fixed at the bottom opening of a vertical glass pipe (3) (length: 60 cm, diameter: 1.5 cm). Then 150 ml of the oil water mixture to be tested is poured into the glass pipe using a funnel and any solvent passing the mesh is collected using a beaker. The volume of organic phase that is not held back by the grid, i.e. collected in the beaker is measured. For each test mixture a fresh grid is used. Each test with a specific oil/water mixture and a specific grid was repeated three times with a freshly prepared grid. All tests were performed at room temperature.

The following oil-water test mixtures were used:

Hexane/Water 30/70 vol %

Toluene/Water 30/70 vol %

Hexane/Toluene/Water 24/6/70 vol %

Cooking (Thistle) oil/Water, 30/70 vol %

Heavy gasoline/Water, 30/70 vol %

Crude oil (oilfield in Northern Germany)/Water, 30/170 vol %

The water phase is colored blue for better visibility with methylene blue. Also emulsions of the mixtures were tested. They were prepared by vigorously shaking the corresponding 2-phase mixtures.

The percentage of oil phase (vol % relating to the total amount of oil used for the test) that is not held back by the grid and passes through the grid is listed in table 1. Since at least three reproduction experiments were performed per grid and per oil/water mixture a range is—if necessary—provided.

TABLE 1
Percentage (vol %) of the oil phase of the tested oil/water mixtures that passes the corresponding grid.

| | | | | | | Hexane/ | | Thistle oil/ | | | Crude oil/ |
|---|---|---|---|---|---|---|---|---|---|---|---|
| | | Pre- | | Hexane/ | Toluene/ | Toluene/ | Thistle oil/ | water | Gasoline/ | Crude oil/ | water |
| | | coating | | water | water | water | water | (30/70) | water | water | (30/70) |
| No. | monomer | with PEI | adhesive agent | (30/70) | (30/70) | (24/6/79) | (30/70) | emulsified | (30/70) | (30/70) | emulsified |
| C1 | acrylamide | no | polyacrylamide | 0% | 100% | 5-20% | 100% | 100% | 100% | 100% | |
| 1 | acrylamide | no | polyacrylic acid | 0% | 0-5% | 0-5% | 0-5% | 0-20% | 5-20% | 5-20% | 5-30% |
| C2 | acrylamide | yes | polyacrylic acid | 0-5% | 100% | 5-20% | 100% | 100% | 5-20% | | |
| 2 | acrylamide + | no | polyacrylic acid | 0% | | 0-5% | | | 5-20% | 20-40% | 20-40% |
| | acrylic acid | | | | | | | | | | |
| C3 | acrylic acid | no | polyacrylic acid | 100% | | | | | | | |

Blank boxes: no measurements were performed

### Long Term Test

With the grid of example No. 1 a long term test was performed. For the test a hexane-water mixture was separated as described above. Thereafter, the oil remaining on the mesh was decanted and then the test repeated using fresh hexane-water-mixture. 170 of such separation cycles were run with one grid with hexane/water mixtures without any loss of performance. After 170 the performance of the mesh became slightly worse but it still separated off most of the oil.

### Discussion

The separation efficiencies of the differently coated grids (see experimental part) for several oil-water mixtures and the corresponding emulsions (see experimental part) were determined. Within this series of different oil-water mixtures, the mixture hexane-water is regarded as the one to be separated easiest while for the gasoline-water and especially crude oil-water mixtures separation is known to be much more challenging.

Comparative example C1 with a coating according to the state-of-the art performs best with a hexane-water mixture and there also is some separation efficiency with a hexane-toluene-water mixture. However, for crude oil-water mixtures, gasoline-water mixtures, thistle oil-water mixtures, and toluene-water mixtures no separation was possible.

For example 1, the same coating composition was used as in comparative example C1, except that the adhesive agent polyacrylamide was substituted by polyacrylic acid. Surprisingly, the exchange of the adhesive agent has a very pronounced effect on the performance in oil-water separation. For no oil-water mixture tested the amount of oil passing through the grid exceeded 30%.

Comparative example C2 demonstrates that an additional precoating with polyethyleneimine, which generally is known as a good adhesion promoter for metal surfaces yielded results far worse than example 1. So, such a precoating can be omitted here.

For example 2 instead of pure acryl amide a mixture of acrylic acid and acryl amide was used. The performance is better than for comparative example C1 but not as good as in example 1. Consequently, a pure polyacrylamide hydrogel seems to be more suitable than a polyacrylamide-polyacrylic acid hydrogel.

Comparative example C3 demonstrates that a total substitution of acryl amide by acrylic acid as monomer no longer yields satisfactory results.

1-26. (canceled)

27. A method of manufacturing a coated mesh for oil-water separation by coating a mesh with a curable coating composition and curing the coating by irradiation with UV comprising radiation and/or by annealing wherein the coating composition comprises at least
a polar solvent or solvent mixture,
a hydrophilic coating precursor selected from the group of
hydrophilic, monoethylenically unsaturated monomers, with the proviso that at least one of the monomers is (meth)acryl amide,
preformed hydrophilic oligomers, and
preformed hydrophilic polymers,
a hydrophilic crosslinker,
a hydrophilic polymerization initiator, and
a hydrophilic polymeric adhesion agent comprising acidic groups.

28. The method according to claim 27, wherein the polymeric adhesion agent comprises —COOH groups.

29. The method according to claim 27, wherein the polymeric adhesion agent comprises units of acrylic acid.

30. They method according to claim 27, wherein the polymeric adhesion agent is polyacrylic acid having a weight average molecular weight M_{w} of at least 1,000,000 g/mol.

31. The method according to claim 27, wherein the polar solvent comprises water.

32. The method according to claim 27, wherein the polar solvent comprises at least 70% by wt. of water relating to the total of all solvents used.

33. The method according to claim 27, wherein the polar solvent is water.

34. The method according to claim 27, wherein the amount of (meth)acrylamide is at least 50% by wt. with respect to all monomers used.

35. The method according to claim 27, wherein the mesh has a mesh size of 10 μm to 100 μm.

36. The method according to claim 27, wherein the mesh is a metal mesh.

37. Method according to claim 36, wherein the metal mesh is made of stainless steel.

38. The method according to claim 27, wherein the curable coating composition is a photochemically curable coating composition.

39. The method according to claim 27, wherein the hydrophilic precursor comprises at least one hydrophilic, monoethylenically unsaturated monomer.

40. A method of manufacturing a coated mesh for oil-water separation by coating a mesh with a photochemically curable coating composition and curing the coating by irradiation with UV comprising radiation wherein the coating composition comprises at least
a polar solvent or solvent mixture comprising at least 70% by wt. of water relating to the total of all solvents used,
at least one hydrophilic, monoethylenically unsaturated monomer, with the proviso that at least 50% by wt.—relating to the total amount of all monomers used—is (meth)acryl amide,
a hydrophilic crosslinker comprising at least two ethylenically unsaturated groups,
a hydrophilic photoinitiator, and
a hydrophilic polymeric adhesion agent comprising acrylic acid,
and wherein the mesh is a metal mesh having a mesh size of 10 μm to 100 μm.

41. The method according to claim 40, wherein the polymeric adhesion agent is polyacrylic acid having a weight average molecular weight M_{w} of at least 1,000,000 g/mol.

42. The method according to claim 40, wherein the mesh is made of stainless steel.

43. The method according to claim 40, wherein only acryl amide is used as monomer.

44. A mesh for oil-water separation comprising a crosslinked hydrophilic coating obtained by the process according to claim 27.

45. The mesh for oil-water separation comprising a crosslinked hydrophilic coating obtained by the process according to claim 40.

46. A process for oil-water separation which comprises passing the oil-water mixture through the mesh according to claim 44.

47. The process according to claim 46, wherein the oil-water mixture is pressed against the mesh thereby allowing water to pass through the mesh while at least part of the oil remains on the mesh.

48. The process according to claim 46, wherein a separating device is used which a least comprises
a first chamber at least comprising an inlet for fluids and an outlet for fluids,
a second chamber connected with the first chamber at least comprising an outlet for fluids and
a coated mesh which separates the first chamber from the second chamber,
wherein the oil-water mixture to be separated is allowed to flow into the first chamber through the inlet applying a suitable pressure, thereby allowing water to pass through the mesh from the first chamber into the second chamber while at least part of the oil remains in the first chamber and removing water through the outlet from the second chamber and oil or an oil-water mixture with decreased water content form the first chamber.

49. The process according to claim 48, wherein the separation is a continuous cross-flow filtration.

50. The process according to claim 46, wherein the oil is selected from the groups of hydrocarbons, crude oil, mineral oils, diesel oil, gasoline, heavy fuel oil, engine oil, vegetable oils, coconut oil, tall oil or rape oil, or silicone oils.

51. The process according to claim 46, wherein the oil is crude oil.

52. The process according to claim 46, wherein the separation is selected from the separation of emulsions of crude oil and water produced from an oil bearing formations, the separation of heavy oil emulsions from oil sands tailings or heavy oil emulsions obtained from SAGD techniques, de-oiling of water, oil sludge dewatering, removal of hydrocarbons from drilling fluids, the separation of oil-water mixtures from tank bottoms at refineries or other storage facilities, collections points for disposable waste oils, waste from chemical factories, ballast water or the removal of oil spills.
